(19) United States
(12) Patent Application Publication
(10) Pub. No.: US 2008/0139246 A1
(43) Pub. Date: Jun. 12, 2008

(54) Information processing apparatus

(75) Inventor: Masato Michinaka, Tokyo (JP)

Correspondence Address: FRISHAUF, HOLTZ, GOODMAN & CHICK, PC, 220 Fifth Avenue, 16TH Floor, NEW YORK, NY, 10001-7708, US

(73) Assignee: KABUSHIKI KAISHA TOSHIBA, Tokyo (JP)

(21) Appl. No.: 11/807,697

(22) Filed: May 30, 2007

(30) Foreign Application Priority Data
Dec. 8, 2006 (JP) P2006-332339

(51) Int. Cl. H04M 1/00

(52) U.S. Cl. 455/557

(57) ABSTRACT

According to an aspect of the invention, there is provided an information apparatus including: a first generation unit configured to generate an information of whether an external recording medium is inserted into the information processing apparatus; and a storage unit configured to store the information.

### CROSS-REFERENCE TO RELATED APPLICATIONS

This application is based on and claims the benefit of priority from the prior Japanese Patent Application No. 2006-332339, filed on Dec. 8, 2006; the entire contents of which are incorporated herein by reference.

### TECHNICAL FIELD

The present invention relates to an information processing apparatus capable of being equipped with an external recording medium.

### BACKGROUND

### Description of Related Art

In recent years, an increasing number of compact cellular phones have been placed on the market. With this trend, related components used in cellular phone are becoming smaller. Such components includes, for example, external terminals, connector and memory cards as recording media.

In particular, memory cards such as the SD Card® have been used as general media cards while assuring compatibility with personal computers or OA (office automation) devices. It is disclosed, by for example JP-A-2006-195592, that the memory cards have been shifting to smaller media such as miniSD® or microSD®.

When used with a cellular phone, such a memory card is repeatedly inserted or removed by the user. The user may lose a memory card of an ever-shrinking size without his/her knowing.

It is possible to remove a memory card less often than ever in order to prevent its loss. However, in order to export various types of data recorded on a memory card to another device, the memory card must be removed at least once from the cellular phone. This leaves the risk of losing a memory card.

In case the user has lost a memory card without his/her knowing, the user may not remember where he/she has removed it from his/her cellular phone. As a result, it is difficult to find the lost memory card.

### SUMMARY OF THE INVENTION

According to an aspect of the invention, there is provided an information apparatus including: a first generation unit configured to generate an information of whether an external recording medium is inserted into the information processing apparatus; and a storage unit configured to store the information.

According to another aspect of the invention, an information apparatus including: a first generation unit configured to generate an information of whether an external recording medium is removed from the information processing apparatus; and a storage unit configured to store the information.

### BRIEF DESCRIPTION OF THE DRAWINGS

In the accompanying drawings:

FIGS. 1A and 1B, each drawing shows an exemplary external configuration of a cellular phone as an information processing apparatus according to an embodiment;

FIGS. 2A and 2B, each drawing shows an exemplary another external configuration of a cellular phone as an information processing apparatus according to the embodiment;

FIG. 3 shows an exemplary internal configuration of a cellular phone as an information processing apparatus according to the embodiment;

FIG. 4 is an exemplary flowchart explaining the recording medium handing information (the inserting information or the removing information) storage processing in the cellular phone shown in FIG. 3;

FIG. 5 exemplary shows the data configuration of recording medium handing information (the inserting information or the removing information) and additional recording medium handing information;

FIG. 6 shows an exemplary configuration of the recording medium handing information (the inserting information or the removing information) stored in the storage;

FIG. 7 shows an exemplary configuration of the recording medium handing information (the inserting information or the removing information) stored in the storage;

FIG. 8 an exemplary flowchart explaining the recording medium handling history display processing in the cellular phone shown in FIG. 3;

FIGS. 9A to 9G, each drawing shows an exemplary display presented on the liquid crystal display in FIG. 3;

FIG. 10 is an exemplary flowchart explaining the recording medium removal notice tone generation processing in cellular phone shown in FIG. 3;

FIG. 11 is an exemplary flowchart explaining further recording medium handing information (the inserting information or the removing information) storage processing in the cellular phone shown in FIG. 3;

FIG. 12 is an exemplary flowchart explaining further recording medium handing information (the inserting information or the removing information) storage processing in the cellular phone shown in FIG. 3; and

FIG. 13 is an exemplary flowchart explaining further recording medium handing information (the inserting information or the removing information) storage processing in the cellular phone shown in FIG. 3.

### DESCRIPTION OF THE EMBODIMENTS

An embodiment of the invention will be described referring to drawings.

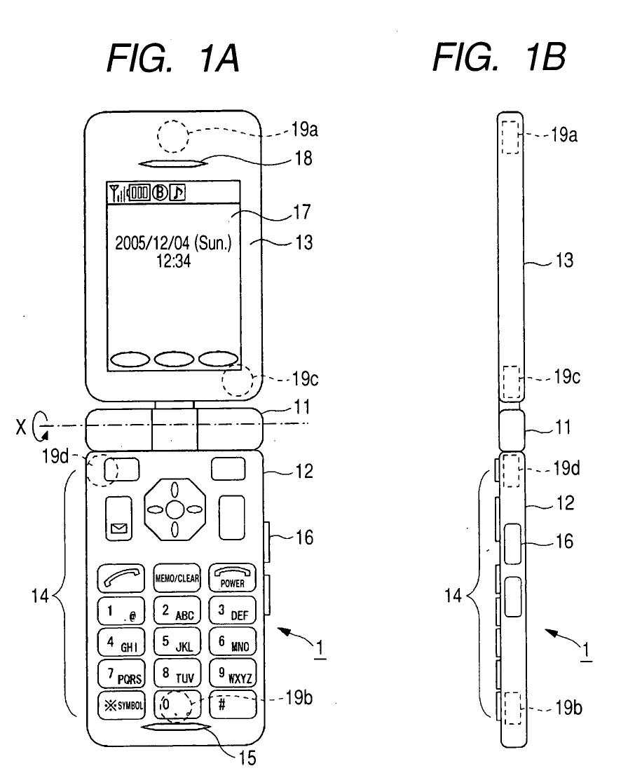

FIGS. 1A and 1B show external configurations of a cellular phone 1 as an information processing apparatus. FIG. 1A represents the external configuration of the cellular phone 1 unfolded about 180 degrees as viewed from the front. FIG. 1B represents the external configuration of the cellular phone 1 unfolded as viewed from the side.

As shown in FIGS. 1A and 1B, the cellular phone 1 has a first casing 12 and a second casing 13 hinged by a central hinge part 11 and is formed in a foldable fashion in the direction of the arrow x via the hinge part 11. In a predetermined position inside the cellular phone 1 is provided an antenna for transmission/reception of radio waves (an antenna 44 in FIG. 3 described later). The cellular phone 1 transmits/receives radio waves to/from a base station (not shown) via the built-in antenna.

On the surface of the first casing 12 are arranged operation keys 14 including numeric keys 0 to 9, an off-hook key, a redial key, an on-hook/power key, a clear key, and an e-mail key. By using the operation keys 14, the user may input various types of instructions.

On the first casing 12 are arranged, in the upper portion, a crosshair key and an enter key as operation keys 14. The user operates the crosshair key horizontally or vertically to move a cursor horizontally or vertically. To be more precise, the user scrolls through a directory list or an e-mail list that appears on a liquid crystal display provided on the second casing 13 as well as performs page turning and image advancing on a simple home page and other types of operations.

The user may validate various types of operations by pressing the enter key. For example, on the first casing 12, a desired directory number is selected from among the plurality of directory numbers in the directory list presented in the liquid crystal display 17 in accordance with the user's operation. With the enter key pressed in the inner direction of the first casing 12, the selected directory number is validated and a call is initiated to the directory number.

On the first casing 12, an e-mail key is arranged to the left of the crosshair key and enter key. When the e-mail key is pressed in the inner direction of the first casing 12, the e-mail communication feature is activated. To the right of the crosshair key and enter key, a browser key is provided. When the browser key is pressed in the inner direction of the first casing 12, the data on a web page can be browsed. The e-mail key and the browser key to the left and right of the crosshair key and enter key may have various features such as “Yes” and “No” depending on the screen presented on the liquid crystal display 17, so that the keys are respectively called the soft 1 key and the soft 2 key.

On the first casing 12, a microphone 15 is provided below the operation keys 14. The microphone 15 is used to collect the voice of the user during conversation. On the first casing 12 is provided a side key 16 for operating the cellular phone 1.

Into the first casing 12 is inserted on the back a battery pack (not shown). When the on-hook/power key is turned ON, power is fed to circuits from the battery pack to activate the cellular phone 1 to place it in the operating state.

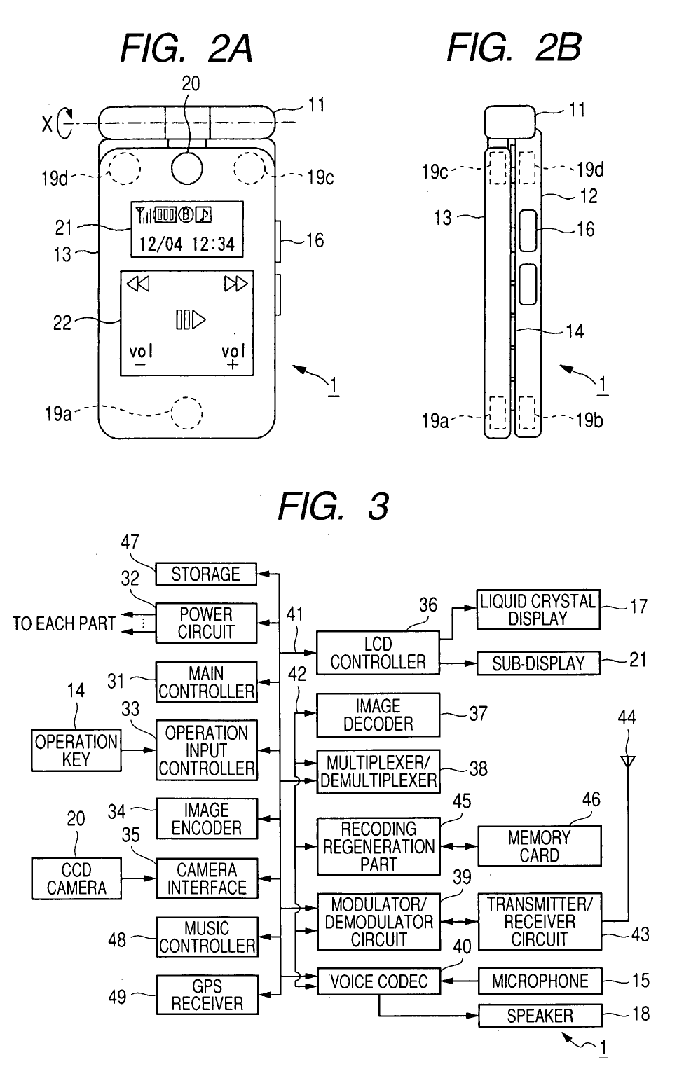

On the second casing 13 is provided a liquid crystal display 17 (main display) in the front. The liquid crystal display 17 serves to display the radio wave receiving state, residual battery power, names of distant parties registered in a directory, corresponding directory numbers and transmission history as well as the content of an e-mail, a simple home page, an image photographed with a CCD (Charge Coupled Device) camera (CCD camera 20 shown in FIGS. 2A and 2B described later), a content received from an external content server (not shown), and a content stored on a memory card (memory card 46 shown in FIG. 3 described later). In a predetermined position in the upper area of the liquid crystal display 17 is provided a speaker 18 used by the user for voice calls.

In predetermined positions inside the first casing 12 and the second casing 13 are provided magnetic sensors 19a, 19b, 19c and 19d for detecting the state of the cellular phone 1.

FIGS. 2A and 2B, each drawing shows another external configuration of the cellular phone 1 as an information processing apparatus. FIG. 2A represents the external configuration of the cellular phone 1 folded as viewed from the front. FIG. 2B represents the external configuration of the cellular phone 1 folded as viewed from the side.

In the upper area of the second casing 13 is provided a CCD camera 20 which allows the user to photograph a desired object. Below the CCD camera 20 is provided a sub-display 21 that presents an antenna pictograph showing the current antenna sensitivity, a battery pictograph showing the residual battery level of the cellular phone 1 and the current time.

Below the sub-display 21 is further provided an electrostatic touch pad 22. The electrostatic touch pad 22 is seemingly a single sheet of touch pad although it includes sensors (not shown) in multiple positions. When the user touches the neighborhood of a sensor, the sensor detects the touch operation to execute rewinding, fast forward, volume down, volume up, playback and temporary stop operations.

FIG. 3 shows the internal configuration of a cellular phone 1 as an information processing apparatus.

As shown in FIG. 3, the cellular phone 1 includes a main controller 31 for universally controlling each part of the first casing 12 and the second casing 13. A main bus 41 interconnects, to the main controller 31, a power circuit 32, an operation input controller 33, an image encoder 34, a camera interface 35, an LCD (Liquid Crystal Display) controller 36, a multiplexer/demultiplexer 38, a modulator/demodulator circuit 39, a voice CODEC 40, a storage 47, a music controller 48, and a GPS receiver 49. Asynchronous bus 42 interconnects the image encoder 34, an image decoder 37, the multiplexer/demultiplexer 38, the modulator/demodulator circuit 39, the voice CODEC 40, and a recording regeneration part 45.

When the on-hook/power key is turned ON by the user, the power circuit 32 feeds power from the battery pack to each part in order to activate the cellular phone 1 to place it in the operating state.

The main controller 31 is composed of a CPU (Central Processing Unit), a ROM (Read Only Memory) and a RAM (Random Access Memory). The CPU executes various types of processing in accordance with a variety of applications loaded from a program stored in the RAM or from the storage 47 as well as generates various control signals and transmits the signals to each part thus universally controlling the cellular phone 1. The RAM stores, as required, data necessary for the CPU to execute various types of processing.

The main controller 31 includes a built-in timer for correctly measuring the current date and time.

The cellular phone 1 converts a sound signal collected with the microphone 15 in a voice call mode to a digital sound signal and compresses the same by the voice CODEC 40, executes spread spectrum processing on the digital sound signal in the modulator/demodulator circuit 39, converts the digital sound signal to an analog signal, executes frequency conversion on the analog signal in a transmitter/receiver circuit 43, and transmits the resulting analog signal via an antenna 44, based on the control of the main controller 31.

The cellular phone 1 amplifies a receive signal received via the antenna 44 in the voice call mode, executes frequency conversion and analog-to-digital conversion on the amplified signal. The cellular phone 1 then executes inverse spread spectrum processing on the signal in the modulator/demodulator circuit 39, expands the signal in the voice CODEC 40, converts the signal to an analog sound signal, and outputs the resulting analog sound signal via the speaker 18.

Further, when transmitting an e-mail in the data call mode, the cellular phone 1 transmits the text data of an e-mail inputted by the operation of the operation key 14 to the main controller 31 via the operation input controller 33. The main controller 31 executes spread spectrum processing on the text data in the modulator/demodulator circuit 39, executes digital-to-analog conversion and frequency conversion on the text data in the transmitter/receiver circuit 43, and transmits the resulting text data to a base station (not shown) via the antenna 44.

When receiving an e-mail in a data call mode, the cellular phone 1 executes inverse spread spectrum processing on a receive signal received from a base station (not shown) via the antenna 44 in the modulator/demodulator circuit 39 and restores the original text data, then displays the text data as an e-mail on the liquid crystal display 17 via the LCD controller 36.

After that, the cellular phone 1 may record an e-mail received in accordance with the user's operation onto a memory card 46 via the recording regeneration part 45.

When not transmitting an image signal, the cellular phone 1 directly displays a signal of an image photographed with the CCD camera 20 on the liquid crystal display 17 via the camera interface 35 and the LCD controller 46.

When transmitting an image signal in the data call mode, the cellular phone 1 supplies a signal of an image photographed with the CCD camera 20 to the image encoder 34 via the camera interface 35.

The image encoder 34 compresses and encodes the image signal supplied from the CCD camera 20 by using a predetermined encoding system such as MPEG (Moving Picture Experts Group) 4 to convert the image signal to an encoded image signal, and transmits the resulting encoded image signal to the multiplexer/demultiplexer 38. At the same time, the cellular phone 1 transmits, as a digital sound signal, the sound collected with the microphone 16 during photography using the CCD camera 20 to the multiplexer/demultiplexer 38 via the voice CODEC 40.

The multiplexer/demultiplexer 38 multiplexes the encoded image signal supplied from the image encoder 34 and the sound signal supplied from the voice CODEC 40 by using a predetermined system. The multiplexer/demultiplexer 38 then executes spread spectrum processing on the resulting multiplexed signal in the modulator/demodulator circuit 39, executes digital-to-analog conversion and frequency conversion on the multiplexed signal in the transmitter/receiver circuit 43, and transmits the signal via the antenna 44.

The cellular phone 1 is capable of receiving data on a web page in the data call mode.

When the cellular phone 1 transmits data requesting a web page in the data call mode, the data on the web page is transmitted via a base station (not shown) in response to the request. The data on the web page is received by the transmitter/receiver circuit 43 and the modulator/demodulator circuit 39. The transmitter/receiver circuit 43 and the modulator/demodulator circuit 39 transmit the received data on the web page to the main controller 31.

The main controller 31 interprets the data on the web page and creates a screen (image) that is based on the interpretation. The screen created is supplied to the liquid crystal display 17 via the LCD controller 36 from the main controller 31 and displayed thereon. That is, at least an application program of a web browser is installed in the ROM of the main controller 31 or the storage 47. The CPU of the main controller 31 executes an application program of a web browser on the RAM thus acting as a web browser and interprets data on the web page.

When receiving data of a moving picture file linked to a web page or the like in the data call mode, the cellular phone 1 executes inverse spread spectrum processing on a receive signal received from a base station (not shown) via the antenna 44 in the modulator/demodulator circuit 39, and transmits the resulting multiplexed signal to the multiplexer/demultiplexer 38.

The multiplexer/demultiplexer 38 demultiplexes a multiplexed signal to separate the same into an encoded image signal and a sound signal, supplies the encoded image signal to the image decoder 37 via the synchronous bus 42 as well as supplies the sound signal to the voice CODEC 40. The image decoder 37 decodes the encoded image signal by using a decoding system supporting a predetermined encoding system such as MPEG4 to generate a playback moving picture signal, and supplies the playback moving picture signal thus generated to the liquid crystal display 17 via the LCD controller 36. This displays moving picture data included in a moving picture file linked to a web page or the like.

At the same time, the voice CODEC 40 converts the sound signal to an analog sound signal and supplies the same to the speaker 18. This reproduces a sound signal included in a moving picture file linked to a web page or the like. In this case, same as the case of an e-mail, the cellular phone 1 is capable of recording, via the recording regeneration part 45, data linked to a web page or the like received onto the memory card 46 by the user's operation.

The storage 47 is composed of for example a flash memory element or an HDD (Hard Disc Drive) as a nonvolatile memory that allows electrical overwriting or erasure and stores various types of application programs executed by the CPU of the main controller 31 and various types of data groups. The storage 47 stores, as required, e-mail data received in accordance with the user's operation and moving picture data included in a moving picture file linked to a received web page or the like.

The music controller 48 controls execution of the playback operation and temporary stop operation of audio data stored in the storage 48 as well as rewinding, fast forward, volume down, and volume up operations.

The GPS receiver 49 receives GPS waves (GPS information such as latitude and longitude information) coming from a GPS broadcast station (not shown).

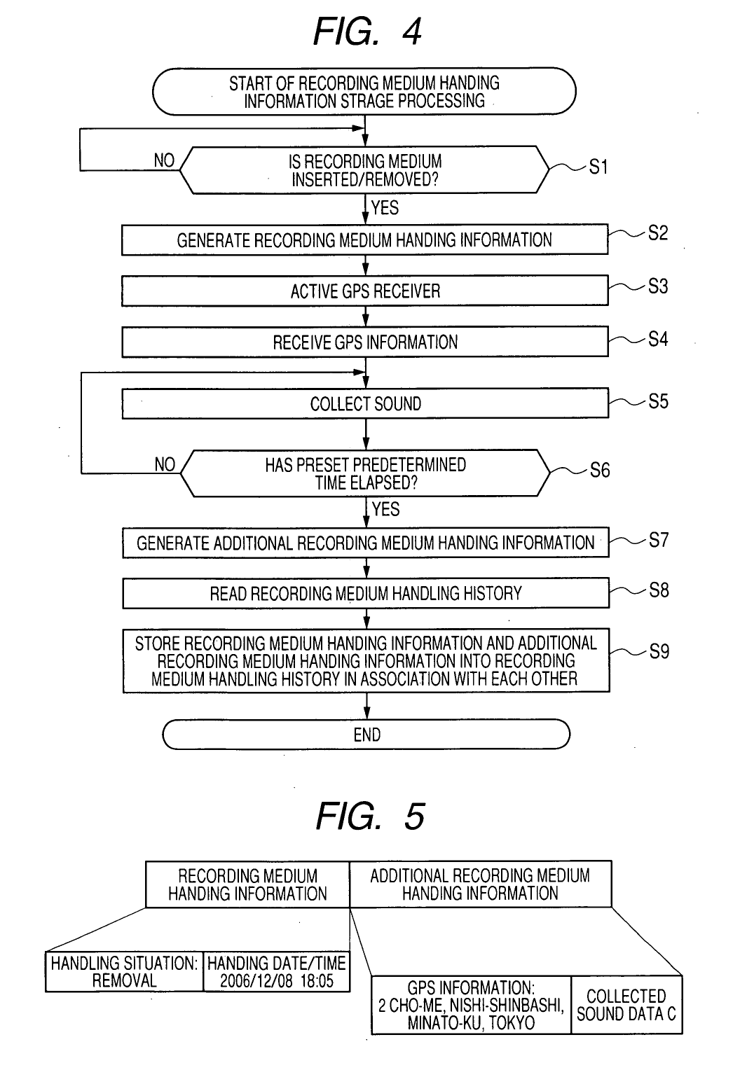

Next, recording medium handling information (an inserting information or a removing information) storage processing in the cellular phone 1 shown in FIG. 3 will be described referring to the flowchart of FIG. 4. The recording medium handling information storage processing is initiated when the user has inserted or removed the memory card 46 as a storage medium.

In step S1, the main controller 31 determines via the recording regeneration part 45 whether the memory card 46 is inserted or removed by the user. The main controller 31 is placed in the standby state until it is determined that the memory card 46 is inserted or removed by the user.

In case it is determined that the memory card 46 is inserted or removed in step S1, the main controller 31 generates recording medium handing information (the inserting information or the removing information) as information used when the memory card 46 as a recording medium is handled.

In particular, the main controller 31 uses the built-in timer to acquire a removal date/time and generates recording medium handing information (the inserting information or the removing information) for example as shown in FIG. 5 based on the acquired removal date/time and the situation of insertion or removal of the memory card 46 determined via the recording regeneration part 45.

In the example of FIG. 5, the recording medium handing information (the inserting information or the removing information) includes information on the removal of the memory card 46 as information on the handling situation and the information “2006/12/08 19:05” as information on the handing date/time.

In step S3, the main controller 31 activate the GPS receiver 49 via the main bus 41. In step S4, the GPS receiver 49 receives GPS information from a GPS broadcast basement (not shown) in accordance with the control of the main controller 31 and supplies the received GPS information to the main controller 31. The main controller 31 acquires the GPS information supplied from the GPS receiver 49.

For example, in case the current location of the cellular phone 1 assumed when the memory card 46 was inserted or removed is “2 cho-me, Nishi-shimbashi, Minato-ku, Tokyo”, the acquired GPS information includes information indicating that the current location is “2 cho-me, Nishi-shimbashi, Minato-ku, Tokyo”. The GPS information is generally composed of a latitude and a longitude. The latitude and longitude information may be stored as it is, or address information corresponding to the latitude and longitude may be stored as described above. When address information corresponding to the latitude and longitude is stored, an external server (not shown) may be accessed to obtain address information. Hereinafter, “GPS information” refers to information such as latitude/longitude information supplied from the GPS receiver 49 and information such as address information corresponding to the information. In the following description, address information is used as a specific example.

In step S5, the main controller 31 controls the microphone 15 to engage the microphone 15 to collect environmental sound in the surroundings of a location where the memory card 46 as a recording medium is handled. The microphone 15 sequentially collects the environmental sound in the surroundings of a location where the memory card 46 as a recording medium is handled.

For example, in case the memory card 46 is removed by the user at the premise of a train station, the train car driving sound of rattling and the hum of passengers' conversation are collected as environmental sound. In case the memory card 46 is removed by the user in an office, the sound of hitting keys of keyboards of PCs from other users is collected as environmental sound.

The main controller 31 controls the voice CODEC 40 to engage the voice CODEC 40 to convert to a digital sound signal and compress the environmental sound in the surroundings of a location where the memory card 46 as a recording medium is handled and temporarily store the compressed digital sound signal (collected sound data) into a RAM in a sequential manner.

In step S6, the main controller 31 uses the built-in timer to determine whether a preset predetermined time (for example five seconds) has elapsed. In case it is determined that the preset predetermined time has not elapsed in step S6, execution returns to step 5, where the environmental sound in the surroundings of a location where the memory card 46 as a recording medium is handled is collected.

In case it is determined that the preset predetermined time has elapsed in step S6, the main controller 31 generates, in step S7, additional recording medium handling information as information to be added to the recording medium handing information (the inserting information or the removing information) (recording medium handing information assumed when a recording medium is handled).

In the example of FIG. 5, the additional recording medium handling information includes information as GPS information indicating that the current location is “2 cho-me, Nishi-shimbashi, Minato-ku, Tokyo” and sound collection data C.

In step S8, the main controller 31 reads the recording medium handling history stored in the storage 47.

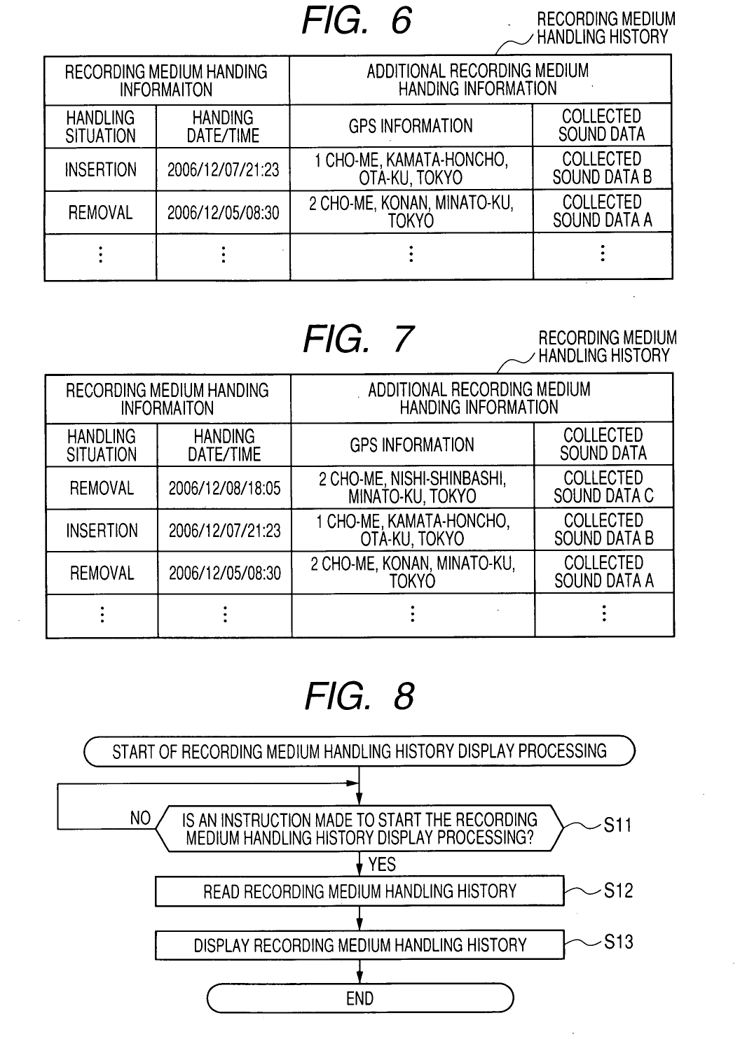

For example, the first to fourth columns of the recording medium handling history shown in FIG. 6 describes, as recording medium handing information (the inserting information or the removing information), “handling situation”, “handling date/time” as well as “GPS information” and “sound collection data” as additional recording medium handing information (the inserting information or the removing information). Respective information items indicates the situation under which the memory card 46 as a recording medium was handled, the date/time when the memory card 46 as a recording medium is handled, information on the cellular phone 1 assumed when the memory card 46 as a recording medium was inserted or removed, and data on the environmental sound in the surroundings collected when the memory card 46 as a recording medium was handled.

For example, in the case of the first row of the recording medium handling history shown in FIG. 6, “handling situation” is “insertion” and the situation assumed when the memory card 46 as a recording medium is “insertion”. The “handling date/time” is “2006/12/07/21:23” which indicates that the date/time when the memory card 46 as a recording medium was handled is “2006/12/07/21:23”. The “GPS information” is “1 cho-me, Kamata-honcho, Ota-ku, Tokyo” and the information on the current location of the cellular phone 1 where the memory card 46 was inserted or removed is “1 cho-me, Kamata-honcho, Oota-ku, Tokyo”. “Collected sound data” is “collected sound data B” indicating that the data on the environmental sound in the surroundings collected when the memory card 46 as a recording medium was handled is “collected sound data B”.

For example, in the case of the second row of the recording medium handling history shown in FIG. 6, “handling situation” is “removal” and the situation assumed when the memory card 46 as a recording medium is “removal”. The “handling date/time” is “2006/12/05/08:30” which indicates that the date/time when the memory card 46 as a recording medium was handled is “2006/12/05/08:30”. The “GPS information” is “2 cho-me, Konan, Minato-ku, Tokyo” and the information on the current location of the cellular phone 1 where the memory card 46 was inserted or removed is “2 cho-me, Konan, Minato-ku, Tokyo”. “Collected sound data” is “collected sound data A” indicating that the data on the environmental sound in the surroundings collected when the memory card 46 as a recording medium was handled is “collected sound data A”.

In step S9, the main controller 31 associates the generated recording medium handing information (the inserting information or the removing information) with the additional recording medium handing information and stores (registers) both information items in the recording medium handling history read from the storage 47. The storage 47 associates the generated recording medium handing information (the inserting information or the removing information) with the additional recording medium handing information in accordance with the control of the main controller 31 and stores (registers) both information items in the recording medium handling history.

For example, the recording medium handling history shown in FIG. 6 is updated as shown in FIG. 7.

In case the user has lost the memory card 46 without his/her knowing and wishes to search for the lost memory card 46, the user reads the recording medium handling history stored in the storage 47 and displays the read recording medium handling history on the liquid crystal display 17. The user thus knows in which place the memory card 46 as a recording medium was last removed and is now ready to search for the lost memory card 46 in an efficient way. The recording medium handling history display processing using this method will be described.

The recording medium handling history display processing in the cellular phone 1 shown in FIG. 3 is described below referring to the flowchart of FIG. 8. The recording medium handling history display processing is initiated upon instruction by the user to start the recording medium handling history display processing by a push on the operation key 14.

In step S11, the main controller 31 determines whether an instruction is made to start the recording medium handling history display processing with a push on the operation key 14 by the user. The main controller 31 is placed in a standby state until it determines that it is instructed to start the recording medium handling history display processing with a push on the operation key 14.

In case it is determined in step S11 that an instruction is made to start the recording medium handling history display processing with a push on the operation key 14 by the user, the main controller 31 reads the recording medium handling history stored in the storage 47 in step S12.

In step S13, the main controller 31 controls the LCD controller 36 to engage the LCD controller 36 to display the read recording medium handling history on the liquid crystal display 17. The liquid crystal display 17 presents the read recording medium handling history in accordance with the control of the LCD controller 36.

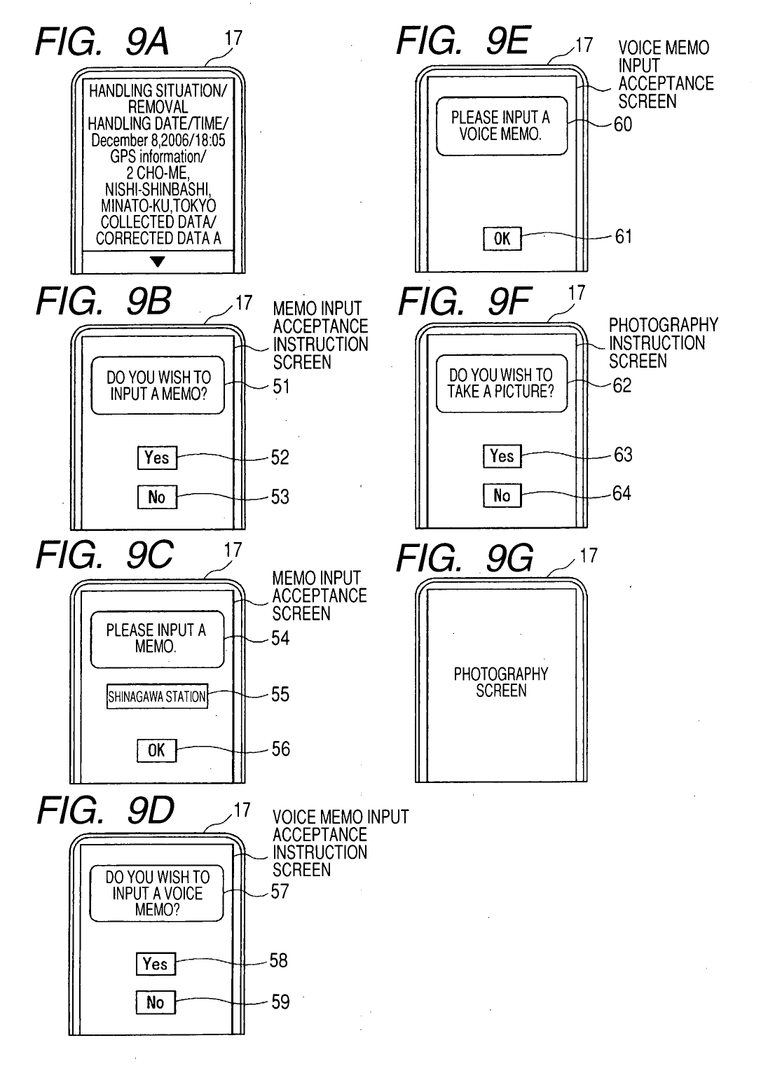

For example, as shown in [A] in FIG. 9, latest information including the handling situation, handling date/time, and GPS information on the memory card 46 as a recording medium is displayed. This lets the user notice that the memory card 46 as a recording medium was last removed at. “2 cho-me, Nishi-shimbashi, Minato-ku, Tokyo” (for example a location of a branch office of a company the user works for). The user is now ready to search for the lost memory card 46 by using the information in an efficient way.

The user may play, as required, the environmental sound in the surroundings collected when the memory card 46 was handled. This allows the user to determine the environment where the memory card 46 as a recording medium was removed from the environmental sound as well as remember his/her action related to removal of the memory card 46 as a recording medium.

As shown in FIG. 9A, the user may use the operation key 14 to scroll through the display screen presented to the liquid crystal display 17 thus checking the history of handling recording media.

According to the embodiment, it is determined whether the memory card 46 as a recording medium is inserted or removed by the user, and in case it is determined that the memory card 46 as a recording medium is inserted or removed by the user, it is possible to generate recording medium handling information as information related to handling of the memory card 46 as a recording medium. In case it is determined that the memory card 46 as a recording medium is inserted or removed by the user, it is possible to receive GPS information and collect the environmental sound in the surroundings of a location where the memory card 46 as a recording medium is handled so as to generate additional recording medium handling information to add to the recording medium handling information based n the received GPS information and collected environmental sound in the surroundings.

It is further possible to store (register) in the recording medium handing history the recording medium handling information and the additional recording medium handling information generated above in association with each other.

In case the user has lost a memory card without his/her knowing, the user can reliably locate where he/she finally removed the memory card from his/her cellular phone, and search the place for the lost memory card 46 in an efficient way.

This upgrades the usability of a recording medium.

A notice tone may be generated to remind the user of the situation where the memory card 46 as a recording medium is being removed when the user takes such action. The recording medium removal notice tone generation processing using this method will be described.

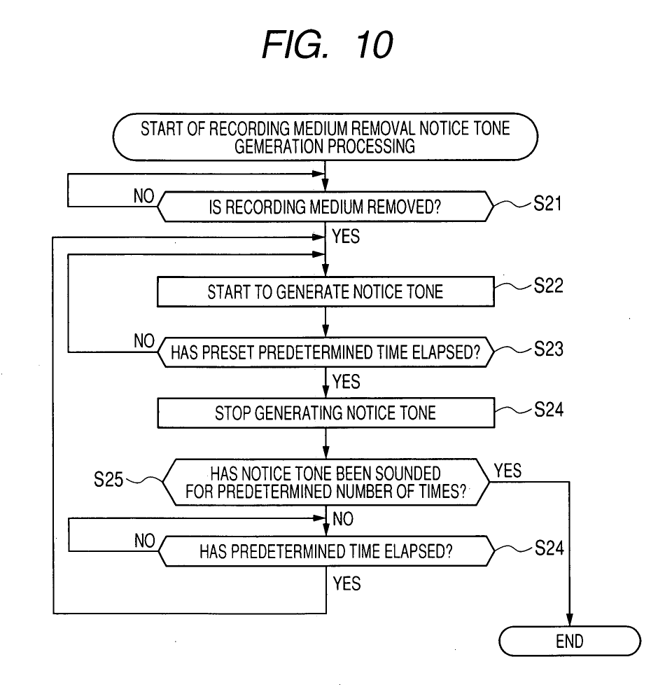

The recording medium removal notice tone generation processing in the cellular phone 1 shown in FIG. 3 is described below referring to the flowchart of FIG. 10. The recording medium removal notice tone generation processing is initiated when the user removes the memory card 46 as a recording medium.

In step S21, the main controller 31 determines via the recording regeneration part 45 whether the memory card 46 is removed by the user and is placed in the standby state until it is determined that the memory card 46 is removed by the user.

In case it is determined in step S21 that the memory card 46 is removed by the user, the main controller 31 reads a notice tone (for example a beep tone) to notify the user of the removal of the memory card 46 and supplies the notice tone to the voice CODEC 40. The notice tone read from the storage 47 is a digital sound signal.

The voice CODEC 40 converts the notice tone as a digital sound signal to a notice tone as an analog sound signal and supplies the resulting notice tone as an analog sound signal to the speaker 18. The speaker 18 acquires the notice tone as an analog sound signal supplied from the voice CODEC 40, outputs the acquired notice tone as an analog sound signal and starts to generate a notice tone.

In step S23, the main controller 31 uses the built-in timer to determine whether a preset predetermined time (for example two seconds) has elapsed. In case it is determined in step S23 that the preset predetermined time has not elapsed, execution returns to step S22, where the notice tone is generated. The notice tone remains sounding until the preset predetermined time (for example two seconds) has elapsed.

In case it is determined in step S23 that the preset predetermined time has elapsed, the main controller 31 controls, in step S24, the speaker 18 to engage it to stop generating the notice tone.

In step S25, the main controller 31 determines whether the notice tone has been sounded (generated) for a preset predetermined number of times (for example two or three times) since the notice tone was started. In case it is determined in step S25 that the notice tone has been sounded (generated) for a preset predetermined number of times, the recording medium removal notice tone generation processing is terminated (“Yes” in step S25). In case it is determined in step S25 that the notice tone has not been sounded (generated) for a preset predetermined number of times, the main controller 31 determines, in step S26, whether a predetermined time (a predetermined time is counted with a timer) has elapsed since the notice tone was silenced in step S24 by using a built-in timer in step S26. In case it is determined in step S26 that the predetermined time has elapsed since the notice tone was silenced in step S24, execution returns to step S22, where generation of the notice tone is started. The notice tone is thus generated repeatedly every predetermined time for a preset predetermined number of times.

The user may thus remove the memory card 46 as a recording medium while recognizing that he/she is removing the same. Even in case the user has lost the memory card 46, he/she readily recalls where he/she has lost the memory card 46.

This upgrades the usability of a recording medium.

A memo input acceptance screen may be presented on the liquid crystal display 17 when additional recording medium handling information is generated for the user to input a reminder memo when inserting or removing the memory card 46 as a recording medium. This allows the user to correctly record where the memory card 46 was inserted or removed as well as recognize that he/she is taking action of inserting or removing the memory card 46. The recording medium handling information storage processing with this method will be described.

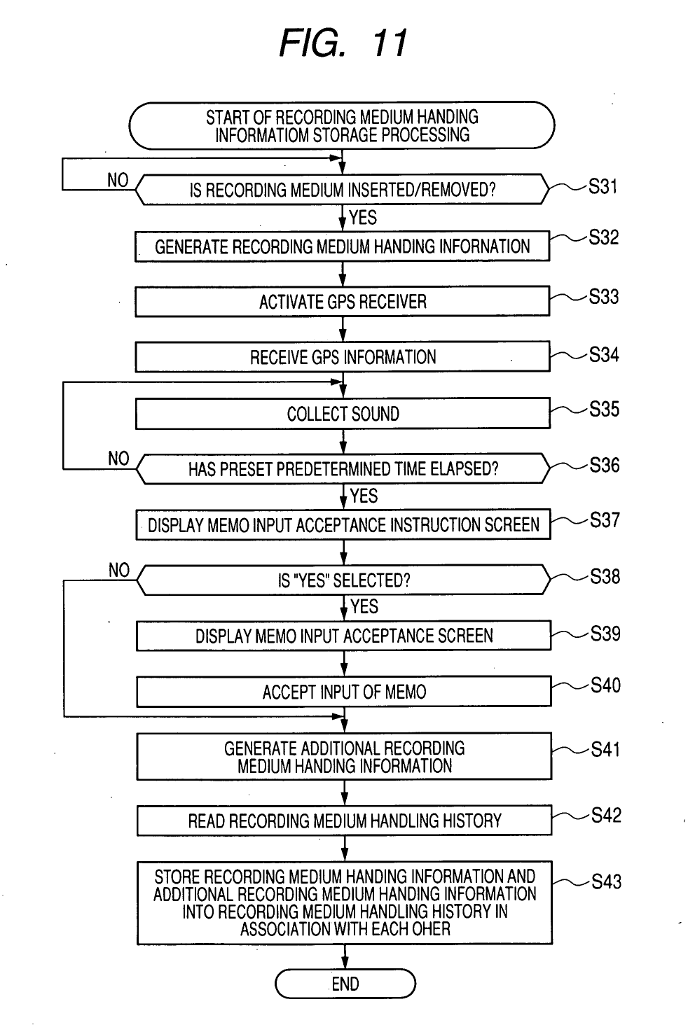

Further recording medium handling information storage processing in the cellular phone 1 shown in FIG. 3 will be described referring to the flowchart of FIG. 11. Processing in steps S31 to S36 and processing in steps S41 to S43 in FIG. 11 are same as the processing in steps S1 to S9 in FIG. 4 so that the corresponding description is omitted to avoid repetition.

In step S37, the main controller 31 controls the LCD controller 36 to engage the liquid crystal display 17 to display a memo, serving as descriptive information, input acceptance instruction screen for instructing memo input. The liquid crystal display 17 displays the memo input acceptance instruction screen for instructing memo input in accordance with the control of the LCD controller 36.

For example, the memo input acceptance instruction screen shown in FIG. 9B includes a message display column 51 and command display columns 52 and 53 for displaying commands.

In the example of FIG. 9B, the message display column 51 displays the message “Do you wish to input a memo?”. This lets the user understand that he/she may instruct memo input acceptance assumed when the memory card 46 is inserted or removed in accordance with the subsequent operation.

The command display columns 52 and 53 respectively include a command icon “Yes” and a command icon “No”. The user may operate the operation key 14 to select the command icon “Yes” in the command display column 52 to instruct start of memo input acceptance. The user may operate the operation key 14 to select the command icon “No” in the command display column 53 to cancel the memo input acceptance processing.

In step S38, the main controller 31 determines whether the memo input acceptance was instructed by the user operating the operation key 14 to select the icon “Yes” in the command display column 52 based on the memo input acceptance instruction screen of FIG. 9B.

To be more specific, in case the user has operated the operation key 14 to select the icon “Yes” in the command display column 52, the main controller 31 determines, in step S38, that the memo input acceptance was instructed by the user operating the operation key 14 to select the icon “Yes” in the command display column 52.

In case it is determined in step S38 that the memo input acceptance was instructed by the user operating the operation key 14 to select the icon “Yes” in the command display column 52, the main controller 31 controls in step S39 the LCD controller 36 to engage the liquid crystal display 17 to display a memo input acceptance screen for accepting memo input. The liquid crystal display 17 displays the memo input acceptance screen for accepting memo input in accordance with the control of the LCD controller 36.

For example, the memo input acceptance screen shown in FIG. 9C includes a message display column 54, a memo input acceptance column 55 and a command display column 56 for displaying commands.

In the example of FIG. 9C, the message display column 54 displays the message “Please input a memo.” This lets the user understand that he/she may input a memo when inserting or removing the memory card 46 in accordance with the subsequent operation.

The memo input acceptance column 56 accepts a memo input to the user's taste. In the example of FIG. 9C, input of the memo “Shinagawa Station” is accepted in the memo input acceptance column 55.

The command display column 56 includes a command icon “OK”. The user may operate the operation key 14 to select the command icon “OK” to instruct validation of the memo input acceptance.

In step S40, the main controller 31 accepts memo input on the memo input acceptance screen based on the operation of the operation key 14 by the user via the operation input controller 33. In the example of FIG. 9C, input of the memo “Shinagawa Station” is accepted in the memo input acceptance column 55. This memo includes text data.

In case it is determined, in step S38, that the icon “Yes” in the command display column 52 is not selected by the user's operation of the operation key 14 and the memo input acceptance is not instructed (that is, in case it is determined that the icon “No” in the command display column 52 is selected and the memo input acceptance is not instructed), processing in steps S39 to S40 is skipped. A memo is not inputted by the user and memo input is not accepted.

In case memo input was accepted by the memo input acceptance processing in step S40, additional recording medium handing information (the inserting information or the removing information) is generated in step S41 based on the GPS information and collected data as well as data concerning a memo whose input is accepted. In case memo input was not accepted by the memo input processing in step S40, additional recording medium handing information (the inserting information or the removing information) is generated in step S41 based on the GPS information and collected data alone.

The user thus has a choice to display the memo on the liquid crystal display 17 at a later date. The user is thus able to correctly record where he/she inserted or removed the memory card 46 and recognize that he/she is inserting or removing the same.

In case the user has lost a memory card without his/her knowing, the user can reliably locate where he/she finally removed the memory card from his/her cellular phone, and search the place for the lost memory card 46 in an efficient way.

This upgrades the usability of a recording medium.

While the memo input acceptance screen is displayed in the recording medium handing information (the inserting information or the removing information) storage processing described using the flowchart of FIG. 11 and input of a memo assumed when the memory card 46 as a recording medium is inserted or removed is accepted based on the user's operation of the operation key 14, the embodiment is not limited thereto but input of a voice memo (aural memo) by the user may be accepted. The recording medium handing information (the inserting information or the removing information) storage processing with this method will be described.

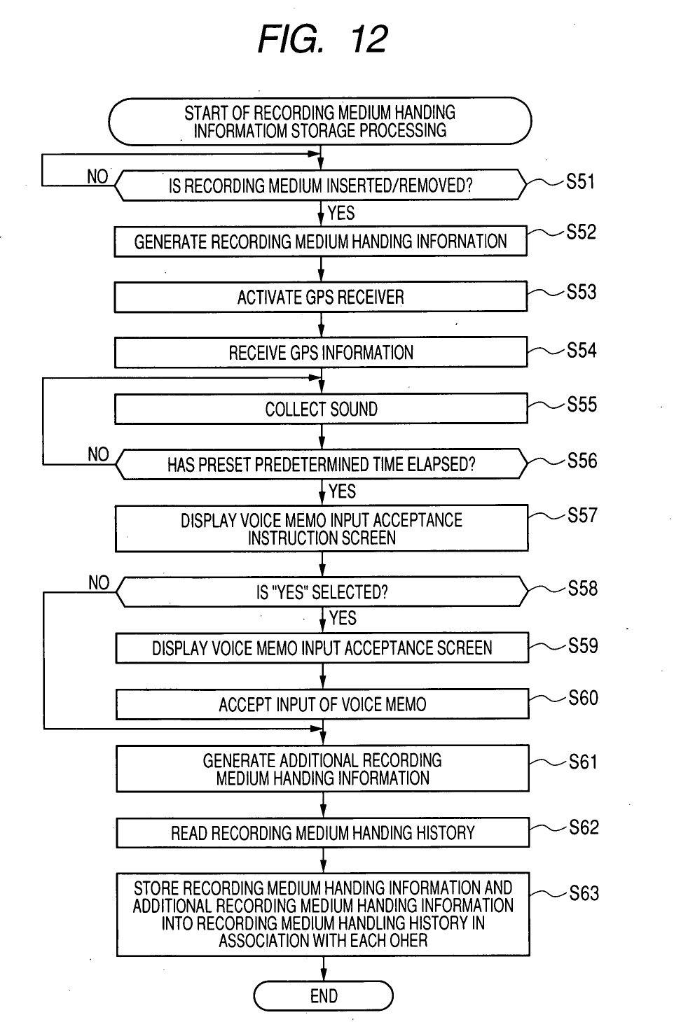

Further recording medium handling information storage processing in the cellular phone 1 shown in FIG. 3 will be described referring to the flowchart of FIG. 12. Processing in steps S51 to S56 and processing in steps S61 to 63 in FIG. 12 are same as the processing in steps S1 to S9 in FIG. 4 so that the corresponding description is omitted to avoid repetition.

In step S57, the main controller 31 controls the LCD controller 36 to engage the liquid crystal display 17 to display a voice memo input acceptance instruction screen for instructing voice memo input. The liquid crystal display 17 displays the voice memo input acceptance instruction screen for instructing voice memo input in accordance with the control of the LCD controller 36.

For example, the memo input acceptance instruction screen shown in FIG. 9D includes a message display column 57 and command display columns 58 and 59 for displaying commands.

In the example of FIG. 9D, the message display column 57 displays the message “Do you wish to input a memo?”. This lets the user understand that he/she may instruct memo input acceptance assumed when the memory card 46 is inserted or removed in accordance with the subsequent operation.

The command display columns 58 and 59 respectively include a command icon “Yes” and a command icon “No”. The user may operate the operation key 14 to select the command icon “Yes” in the command display column 58 to instruct start of voice memo input acceptance. The user may operate the operation key 14 to select the command icon “No” in the command display column 59 to cancel the voice memo input acceptance processing.

In step S58, the main controller 31 determines whether the voice memo input acceptance was instructed by the user operating the operation key 14 to select the icon “Yes” in the command display column 58 based on the voice memo input acceptance instruction screen of FIG. 9D.

To be more specific, in case the user has operated the operation key 14 to select the icon “Yes” in the command display column 58, the main controller 31 determines, in step S58, that the voice memo input acceptance was instructed by the user operating the operation key 14 to select the icon “Yes” in the command display column 58.

In case it is determined in step S58 that the voice memo input acceptance was instructed by the user operating the operation key 14 to select the icon “Yes” in the command display column 58, the main controller 31 controls in step S59 the LCD controller 36 to engage the liquid crystal display 17 to display a voice memo input acceptance screen for accepting voice memo input. The liquid crystal display 17 displays the voice memo input acceptance screen for accepting voice memo input in accordance with the control of the LCD controller 36.

For example, the voice memo input acceptance screen shown in FIG. 9E includes a message display column 60 and a command display column 61 for displaying commands.

In the example of FIG. 9E, the message display column 60 displays the message “Please input a voice memo.” This lets the user understand that he/she may input a voice memo when inserting or removing the memory card 46 in accordance with the subsequent operation.

The command display column 61 includes a command icon “OK”. The user may operate the operation key 14 to select the command icon “OK” to instruct validation of the voice memo input acceptance.

In step S60, the main controller 31 accepts input of a voice memo by the user's voice via a microphone 15. For example, input of the voice memo “The memory card is removed at Shinagawa Station.” is accepted.

The main controller 31 controls the voice CODEC 40 to convert to a digital sound signal and compress the voice memo (for example “The memory card is removed at Shinagawa Station.”) assumed when the memory card 46 as a recording medium is handled and temporarily store onto a RAM the compressed digital sound signal (voice memo data) in a sequential fashion.

In case it is determined, in step S58, that the icon “Yes” in the command display column 58 is not selected by the user's operation of the operation key 14 and the memo input acceptance is not instructed (that is, in case it is determined that the icon “No” in the command display column 58 is selected and the memo input acceptance is not instructed), processing in steps S59 to S60 is skipped. A voice memo is not inputted by the user and voice memo input is not accepted.

In case voice memo input was accepted by the memo input acceptance processing in step S60, additional recording medium handing information (the inserting information or the removing information) is generated in step S61 based on the GPS information and collected data as well as data concerning a memo whose input is accepted. In case voice memo input was not accepted by the voice memo input processing in step S60, additional recording medium handing information (the inserting information or the removing information) is generated in step S61 based on the GPS information and collected data alone.

The user thus has a choice to reproduce the voice memo at a later date. The user is thus able to correctly record where he/she inserted or removed the memory card 46 and recognize that he/she is inserting or removing the same.

In case the user has lost a memory card without his/her knowing, the user can reliably locate where he/she finally removed the memory card from his/her cellular phone, and search the place for the lost memory card 46 in an efficient way.

This upgrades the usability of a recording medium.

While the memo input acceptance screen is displayed in the recording medium handing information (the inserting information or the removing information) storage processing described using the flowchart of FIG. 11 and input of a memo assumed when the memory card 46 as a recording medium is inserted or removed is accepted based on the user's operation of the operation key 14, the embodiment is not limited thereto but an image, such as a still picture, and a moving picture, may be imaged by a CCD camera 20 by the user with arbitrary timing. The recording medium handing information (the inserting information or the removing information) storage processing with this method will be described.

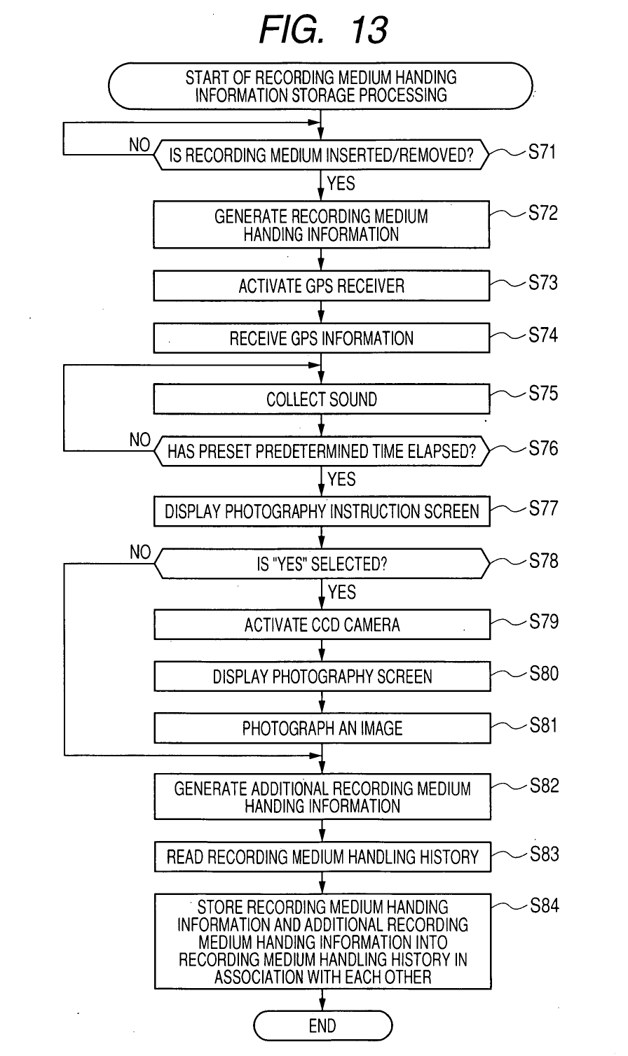

Further recording medium handling information storage processing in the cellular phone 1 shown in FIG. 3 will be described referring to the flowchart of FIG. 13. Processing in steps S71 to S76 and processing in steps S82 to S84 in FIG. 13 are same as the processing in steps S1 to S9 in FIG. 4 so that the corresponding description is omitted to avoid repetition.

In step S77, the main controller 31 controls the LCD controller 36 to engage the liquid crystal display 17 to display a photography instruction screen for instructing photography of a still picture or a moving picture assumed when the memory card 46 is inserted or removed. The liquid crystal display 17 displays the photography instruction screen for instructing photography of a still picture or a moving picture assumed when the memory card 46 is inserted or removed in accordance with the control of the LCD controller 36.

For example, the photography instruction screen shown in FIG. 9F includes a message display column 61 and command display columns 63 and 64 for displaying commands.

In the example of FIG. 9F, the message display column 62 displays the message “Do you wish to take a picture?”. This lets the user understand that he/she may instruct photography of an image assumed when the memory card 46 is inserted or recorded in accordance with the subsequent operation.

The command display columns 63 and 64 respectively include a command icon “Yes” and a command icon “No”. The user may operate the operation key 14 to select the command icon “Yes” in the command display column 63 to instruct start of photography of a still picture or a moving picture assumed when the memory card 46 is inserted or removed. The user may operate the operation key 14 to select the command icon “No” in the command display column 64 to cancel the photography of a still picture or a moving picture assumed when the memory card 46 is inserted or removed.

In step S78, the main controller 31 determines whether the photography of a still picture or a moving picture assumed when the memory card 46 is inserted or removed is instructed by the user operating the operation key 14 to select the icon “Yes” in the command display column 63 based on the photography instruction screen of FIG. 9F.

To be more specific, in case the user has operated the operation key 14 to select the icon “Yes” in the command display column 63, the main controller 31 determines, in step S78, that the photography of a still picture or a moving picture assumed when the memory card 46 is inserted or removed is instructed.

In case it is determined in step S78 that the photography of a still picture or a moving picture assumed when the memory card 46 is inserted or removed was instructed by the user operating the operation key 14 to select the icon “Yes” in the command display column 63, the main controller 31 activates the CCD camera 20 via a camera interface 35 in step S79.

In step S80, the main controller 31 controls the LCD controller 36 to engage the liquid crystal display 17 to display a photography screen for photography using the CCD camera 20. The liquid crystal display 17 displays the photography screen for photography using the CCD camera 20 as shown in FIG. 9G in accordance with the control of LCD controller 36.

Upon a push on the enter key or the like among the operation keys 14 by the user, the main controller 31 controls, in step S81, the CCD camera 20 via a camera interface 35 to cause the CCD camera 20 to photograph a still picture or a moving picture. The CCD camera 20 photographs a still picture or a moving picture in accordance with the control of the main controller 31.

The CCD camera 20 supplies the signal of a photographed image to an image encoder 34 via the camera interface 35.

The main controller 31 controls the image encoder 34 to engage the image encoder 34 to convert the image signal supplied from the CCD camera 20 to an encoded image signal by compressing and encoding the image signal by a predetermined encoding system such as the MPEG (Moving Picture Experts Group) 4 and temporarily store the resulting encoded image signal into a RAM.

In case it is determined, in step S78, that photography of a still picture or a moving picture assumed when the memory card 46 is inserted or removed is not instructed by the user's operation of the operation key 14 without the icon “Yes” in the command display column 63 being selected (that is, in case is not selected by the user's operation of the operation key 14 and the memo input acceptance is not instructed (that is, in case it is determined that the icon “No” in the command display column 64 is selected and photography of a still picture or a moving picture assumed when the memory card 46 is inserted or removed is not instructed), processing in steps S79 to S81 is skipped. Photography of a still picture or a moving picture assumed when the memory card 46 is inserted or removed does not take place.

In case voice memo input was accepted by the memo input acceptance processing in step S60, additional recording medium handing information (the inserting information or the removing information) is generated in step S61 based on the GPS information and collected data as well as data concerning a memo whose input is accepted. In case voice memo input was not accepted by the voice memo input processing in step S60, additional recording medium handing information (the inserting information or the removing information) is generated in step S61 based on the GPS information and collected data alone.

The user thus has a choice to reproduce the voice memo at a later date. The user is thus able to correctly record where he/she inserted or removed the memory card 46 and recognize that he/she is inserting or removing the same.

In case the user has lost a memory card without his/her knowing, the user can reliably locate where he/she finally removed the memory card from his/her cellular phone, and search the place for the lost memory card 46 in an efficient way.

This upgrades the usability of a recording medium.

While GPS information is received as information on the current location of the user assumed when the memory card 46 serving as a recording medium is inserted or removed and the received GPS information is received in the embodiment, other information such as base station information from a base station (not shown) may be used. In case GPS information cannot be received from a GPS broadcast basement (not shown), GPS information may be excluded from the additional recording medium handing information (the inserting information or the removing information). Such GPS information or base station information may be frequently updated before additional recording medium handing information (the inserting information or the removing information) is generated when the cellular phone 1 is traveling frequently. Otherwise, the GPS information or base station information already at hand may be used to generate additional recording medium handing information (the inserting information or the removing information).

In the recording medium handing information (the inserting information or the removing information) storage processing using the flowcharts of FIGS. 4 and 11 to 13, recording medium handing information (the inserting information or the removing information) and additional recording medium handing information as information to be added to the recording medium handing information are generated in this order and the recording medium handing information and the additional recording medium handing information thus generated are stored in the recording medium handing information history with relation to each other. The embodiment is not limited to such a case but only the recording medium handing information (the inserting information or the removing information) including the handling date and handling situation may be generated and stored so as to allow the user to know at least where the memory card 46 as a recording medium was removed. The recording medium handing information (the inserting information or the removing information) to be stored must include at least information on the last handling of the memory card 46 (information on the handling date and handling situation).

On top of the GPS information and collected sound data, information such as information on the ambient temperature and humidity assumed when the memory card 46 is inserted or removed as well as the residual battery power may be used to generate additional recording medium handing information (the inserting information or the removing information).

A confirmation tone may be generated or confirmation display may be presented at a specific operation such as placing the cellular phone 1 from folded state to unfolded state or turning the power ON/OFF. This feature may be turned OFF in accordance with the user's choice.

This attracts the user's attention when he/she is handling the memory card 46 so as to prevent possible loss of the memory card 46 without his/her knowing.

While the above-described embodiments are applied to the memory card 46 as a recording medium, the embodiments are applicable to any type of recording medium that is likely to be lost.

The above-described embodiments are applicable to the cellular phone 1 as well as a PDA (Personal Digital Assistant), a personal computer, a handheld game machine, a handheld music player, a handheld video player and other types of information processing apparatuses.

A series of processing described in the above embodiment may be executed by software as well as by hardware.

While the steps in each flowchart are chronologically executed in the order they are described in the above embodiment, the steps need not always be executed chronologically but may include those executed in parallel or individually executed.

According to the above-described embodiments, it is possible to upgrade the usability of a recording medium.

What is claimed is:

1. An information processing apparatus, comprising
a first generation unit configured to generate an inserting information of whether an external recording medium is inserted into the information processing apparatus; and
a storage unit configured to store the information.

2. The information processing apparatus according to claim 1, wherein the inserting information includes a date/time when the external recording medium is inserted into the information processing apparatus.

3. The information processing apparatus according to claim 1, further comprising:
a second generation unit configured to generate an additional information to be added to the inserting information, wherein the storage unit stores the additional information in association with the inserting information.

4. The information processing apparatus according to claim 3, wherein the additional information includes a positional information of the information processing apparatus.

5. The information processing apparatus according to claim 4, wherein the positional information includes a GPS information received from a GPS broadcast basement.

6. The information processing apparatus according to claim 4, wherein the additional information includes, in addition to the positional information, a sound information around the information processing apparatus.

7. The information processing apparatus according to claim 4, the additional information includes, in addition to the positional information, a memo input by a user.

8. The information processing apparatus according to claim 4, the additional information includes, in addition to the positional information, an image.

9. The information processing apparatus according to claim 4, wherein the positional information includes a base station information received from a base station.

10. The information processing apparatus according to claim 9, wherein the additional information includes, in addition to the positional information, a sound information around the information processing apparatus.

11. The information processing apparatus according to claim 9, the additional information includes, in addition to the positional information, a memo input by a user.

12. The information processing apparatus according to claim 9, the additional information includes, in addition to the positional information, an image.

13. An information processing apparatus, comprising
a first generation unit configured to generate an information of whether an external recording medium is removed from the information processing apparatus; and
a storage unit configured to store the information.

14. The information processing apparatus according to claim 13, wherein the information includes a date/time when the external recording medium is removed from the information processing apparatus.

15. The information processing apparatus according to claim 13, comprising:
a second generation unit configured to generate an additional information to be added to the information, wherein the storage unit stores the additional information in association with the information.

16. The information processing apparatus according to claim 15, wherein the additional information includes a positional information of the information processing apparatus.

17. The information processing apparatus according to claim 16, wherein the positional information includes a GPS information received from a GPS broadcast basement.

18. The information processing apparatus according to claim 17, wherein the additional information includes, in addition to the positional information, a sound information around the information processing apparatus.

19. The information processing apparatus according to claim 16, wherein the positional information includes a base station information received from a base station.

20. The information processing apparatus according to claim 16, wherein the additional information includes, in addition to the positional information, a sound information around the information processing apparatus.
